(19) United States
(12) Patent Application Publication
(10) Pub. No.: US 2021/0354798 A1
(43) Pub. Date: Nov. 18, 2021

(54) DRONE FOR TRIGGERING NAVAL MINES, HAVING AN ELECTRIC DRIVE

(71) Applicant: Siemens Energy Global GmbH & Co. KG, München (DE)

(72) Inventors: Jörn Grundmann, Grossenseebach, Bayern (DE); Michael Wycisk, Mönkeberg (DE)

(73) Assignee: Siemens Energy Global GmbH & Co. KG, Munich, Bayern (DE)

(21) Appl. No.: 17/278,295

(22) PCT Filed: Sep. 18, 2019
(86) PCT No.: PCT/EP2019/074933

§ 371 Date: Mar. 20, 2021

(30) Foreign Application Priority Data
Oct. 9, 2018 (DE) 10 2018 217 211.0

(51) Int. Cl. B63G 7/06; F42B 19/24; F42D 5/04; B63G 8/00; H02K 19/02; H02K 21/28; H02K 21/44; H02K 23/04; H01F 6/00; H01F 1/055

(52) U.S. Cl. CPC B63G 7/06; F42B 19/24; F42D 5/04; B63G 8/001; H02K 19/02; B63G 2007/005; H02K 21/44; H02K 23/04; H01F 6/008; H01F 1/055; H02K 21/28

(57) ABSTRACT

A drone for triggering naval mines, which drone includes a drive having an electric motor for locomotion in the water, wherein the electric motor can be used additionally to trigger the naval mines during operation of the drone, by an external magnetic field formed by the operation of the electric motor. The electric motor includes a stationary stator and a rotor, which is mounted for rotation relative to the stator. The stator includes at least one magnetic and/or electromagnetic element for forming an excitation field. The rotor includes at least one armature winding, which electromagnetically interacts with the excitation field during operation of the electric motor, whereby a superordinate magnetic field is formed. The external magnetic field formed outside of the electric motor during operation is in the form of a constant magnetic field.

### CROSS REFERENCE TO RELATED APPLICATIONS

This application is the US National Stage of International Application No. PCT/EP2019/074933 filed 18 Sep. 2019, and claims the benefit thereof. The International Application claims the benefit of German Application No. DE 10 2018 217 211.0 filed 9 Oct. 2018. All of the applications are incorporated by reference herein in their entirety.

### FIELD OF INVENTION

The present invention relates to a drone for triggering naval mines, which has a drive with an electric motor for locomotion in the water.

### BACKGROUND OF INVENTION

In the case of known systems for the remote clearance of naval mines, unmanned drones are used, equipped with magnetic coils for triggering magnetic mines. These coils generate strong magnetic fields, which can cause the naval mines to detonate. In this case, the drones are configured in such a way that, at the distance typical for triggering, they are not damaged by the detonation.

Such drones may have a drive system of their own, for example the German Navy has remotely controllable boats of the “Seehund” (Seal) type, which are equipped with a diesel engine. The magnetic coil for triggering the mines is in this case integrated in the hull of the remotely controllable boats. The magnetic coil itself is in this case typically formed by a multiplicity of turns of copper cable.

In addition to such drones that float on the surface, there are also known underwater minesweeping drones, which may either also have a drive of their own or be towed along by other (under)water vessels. Also in that case, however, according to the prior art, the magnetic coil is formed as a unit separate from the drive device.

The disadvantage of these conventional minesweeping drones is that, because of the great weight of the magnetic coils required for the strong magnetic fields, they are very heavy and usually also relatively large. So, transporting such drones to different operating locations is relatively hard, in particular transport by aircraft is made considerably more difficult due to the great weight. In the case of drones with their own drive, the drive motor additionally contributes to the great weight and volume. Furthermore, an energy supply is also additionally necessary for the drive, for example in the form of fuel for a diesel engine or else in the form of electrically stored energy for the electric motor.

DE102016203341A1 describes a drone for triggering naval mines by means of an external magnetic field, here the magnetic field being generated by the operation of the electric motor used for the drive. For this purpose, the electric motor used for the drive has a comparatively weak magnetic shielding, so that the magnetic field of the motor can spread out far. In the case of this electric motor, the exciter unit with the magnetic field-generating elements (that is to say for example permanent magnets or magnetic coils) is arranged on the rotor. The excitation field thus generated, which can extend through the weak shielding into the stationary outer surroundings of the drone, is therefore an alternating magnetic field, in the case of which the spatial orientation of the magnetic poles rotates periodically. Consequently, such a minesweeping drone is only suitable for naval mines that are designed to be detonated by alternating magnetic fields with a suitable rotational frequency. As a result, the application area for such minesweeping drones is limited.

### SUMMARY OF INVENTION

An object of the invention is therefore to provide a drone for triggering naval mines by means of an external magnetic field that overcomes the stated disadvantages. In particular, it is intended to provide a drone that can be of a comparatively small and lightweight form and nevertheless has a drive of its own and also a magnetic triggering system that can be used for many types of naval mines.

These objects are achieved by the drone described in the independent claim. The drone according to the invention is suitable for triggering naval mines. It has a drive with an electric motor for locomotion in the water. This electric motor can be additionally used during operation of the drone for triggering the naval mines, specifically by means of an external magnetic field formed by the operation of the electric motor. The electric motor comprises a fixed stator and a rotor mounted rotatably in relation to the stator. In this case, the stator has at least one magnetic or electromagnetic element for forming an excitation field. The rotor has at least one armature winding, which during the operation of the electric motor interacts electromagnetically with the excitation field, whereby a superordinate magnetic field is formed. The external magnetic field thereby formed during the operation of the electric motor in the region outside the electric motor is in this case formed as a constant magnetic field.

In the case of the electric motor of the drone according to the invention, therefore, the exciter device—in other words the device that has the at least one magnetic or electromagnetic element for forming an excitation field—is arranged in the fixed stator. The term “fixed” is intended in the present connection to mean a fixed arrangement within the reference system of the drone within which the electric motor is mounted. The drone as a whole is of course nevertheless intended to be movable in the water, as described, and consequently not to be fixed in an absolute sense. The arrangement of the exciter device on the fixed stator therefore achieves the effect that the generated magnetic excitation field in the spatial reference system of the drone is a constant magnetic field.

The electromagnetic interaction of the excitation field with the rotating armature winding of the rotor has the overall effect of forming a superordinate magnetic field, which is not completely constant because of the interaction with the rotating components. Rather, a constant magnetic field that has a pulsating—that is to say periodically variable—amplitude is formed as the superordinate magnetic field. As a difference from an alternating magnetic field, here however there is no periodic rotation of the spatial position of the magnetic poles. Rather, it is referred to as a constant magnetic field in spite of the amplitude variation.

Said armature winding is intended here to be understood as meaning generally the winding of the motor that interacts electromagnetically with the excitation field of the exciter device. In the case of an electric motor, this is generally the winding via which electrical energy is introduced into the motor. This applies independently of whether the electric motor is designed as a DC motor or as a synchronous motor. Both variants can be advantageously realized within the scope of the invention, the design as a synchronous machine with a rotating armature winding tending to be unusual in the prior art as a whole.

The electric motor of the drone according to the invention is designed in such a way that during its operation a magnetic flux suitable for triggering naval mines can spread into a region outside the electric motor. For this purpose, the electric motor is formed as a whole in such a way as not to prevent such a great part of the magnetic flux from spreading into these outer regions outside the electric motor. It should therefore have altogether comparatively weak magnetic shielding. This can be achieved in particular by the choice of suitable, weakly magnetically shielding materials in the region of a possibly present motor housing, stator support and/or rotor support.

A major advantage of the drone according to the invention is that the magnetic field used during the operation of the electric motor for the drive can be additionally used for triggering the naval mines. In the case of conventional electric motors, the spreading of magnetic flux into outer regions is typically prevented, for instance in order to comply with customary requirements for electromagnetic compatibility. For this purpose, magnetic flux-carrying materials are used, keeping the magnetic flux enclosed in a ring around the inner components of the motor and preventing the flux from spreading into regions lying outside the motor. Such magnetic shielding is advantageously avoided in the case of the electric motor of the drone according to the invention.

During the operation of minesweeping drones in waters where mines have been laid, said requirements for electromagnetic compatibility are generally irrelevant, and it is possible to dispense with the usual shielding of the magnetic flux. In this way it can be achieved that the electric motor performs a dual function, in that it is used not only for the drive but also for triggering the mines. The weight and space for an additional magnetic coil are saved, and the drone can be configured as particularly lightweight and small in comparison with the prior art. As a result, it can advantageously also be transported well and operated in an energy-saving manner.

The major advantage of the drone according to the invention in comparison with the drone of DE102016203341A1 can be seen in that the external magnetic field used for triggering the mines is formed here as a constant magnetic field. As a result, the area of use of such a minesweeping drone is extended to naval mines that can be detonated by a constant magnetic field.

Advantageous refinements and developments of the invention are provided by the dependent claims and the following description.

Thus, the electric motor according to a first advantageous configurational variant is formed in such a way that the rotor is arranged radially inside the stator. In other words, it can be a so-called internal-rotor machine. This configurational variant is particularly advantageous in general in connection with the present invention, because the exciter device is then located in the external stator, and it is consequently particularly easy to use the exciter device for generating a constant magnetic field which, with correspondingly weak shielding of the motor, can spread from the radially external stator into the surrounding regions outside the motor. An advantage of this configurational variant is for example that, if the rotor lies radially on the inside, the components of the rotor do not contribute to undesired outward magnetic shielding of the excitation field. As a result, a comparatively high external constant magnetic field can be generated if a motor housing that is expediently present and a stator support that is expediently present are in each case configured in a correspondingly weakly magnetically shielding manner.

According to a second advantageous configurational variant, it is however also possible in principle that the stator is arranged radially inside the rotor. In the case of such an embodiment, the exciter device is then arranged on a smaller radius than the armature winding. With a correspondingly weakly magnetically shielding design of a rotor support that is expediently present, an external constant magnetic field that is correspondingly high and suitable for triggering naval mines can also be generated in the case of this variant. However, the electromagnetic interaction of the excitation field with the in this case outer rotating armature winding of the rotor has the effect in the case of this variant that a stronger periodic variation in the amplitude of the external constant magnetic field is produced. In some circumstances, this may however also be advantageous for the triggering of certain naval mines that require a quite specific magnetic signature for them to be detonated.

The stator of the electric motor may generally advantageously have a stator support. Such a stator support may be expediently designed for mechanically supporting the exciter device—that is to say the at least one magnetic and/or electromagnetic element for forming an excitation field. The exciter device may in this case in principle be attached radially on the inside or on the outside of the stator support or else be embedded in it. As an alternative or in addition, the rotor of the electric motor may have a rotor support. Such a rotor support may expediently be designed for mechanically supporting the armature winding.

It is however particularly advantageous in connection with the present invention if the magnetic properties of the stator support and/or the rotor support are designed in such a way that during the operation of the electric motor a magnetic flux of at least 0.5 mT can spread into a region outside the electric motor. If it is an internal-rotor machine, that is to say that the stator is arranged radially outside, essentially the magnetic properties of the stator support are decisive for such sufficiently weak shielding of the magnetic flux. If, however, in the case of an external-rotor machine the stator is arranged radially on the inside, expediently both the rotor support and the stator support are formed from sufficiently weakly magnetically shielding materials.

Quite generally and independently of the exact design of the electric motor and the rest of the drone, an external magnetic flux of at least approximately 0.5 mT allows triggering of typical naval mines.

In order to achieve the described comparatively weak magnetic shielding, the stator support and/or the rotor support may be formed at least in some portions from a material that has an effective permeability number μᵣ—also known as relative permeability—of at most 300. Particularly advantageously, the effective permeability number μᵣ is only at most 10 or even only at most 5. The choice of such an amagnetic material can achieve the effect that the magnetic flux can penetrate the respective support sufficiently well.

For example, the stator support and/or the rotor support may be formed at least in some portions from a material which comprises an amagnetic steel and/or plastic. Such a plastic-containing material may advantageously be for example a resin, a thermoplastic, a thermoset and/or a glass-fiber-reinforced plastic.

The electric motor may generally also have a housing, which is advantageously likewise formed amagnetically. In this way it can be achieved that the magnetic flux also penetrates such a motor housing, and that a sufficiently high external magnetic field for triggering a magnetic mine can be generated.

Generally and independently of the respective configuration of the electric motor, it may be designed in such a way that during the operation of the electric motor the external magnetic field formed by the superordinate magnetic field outside the electric motor has there, at least in a partial region, a magnetic flux density of at least 5 mT, in particular at least 50 mT or even at least 500 mT. With such high magnetic flux densities, a magnetic mine can be detonated even from a relatively great distance. In particular, such high magnetic flux densities can also be obtained outside the drone. For this purpose, an outer wall of the drone may also be formed from amagnetic material. An amagnetic material is intended to be understood in connection with the present invention as meaning generally a material with a relative permeability μᵣ of at most 300.

The described amagnetic design of the respectively outer support and the consequently absent magnetic annular enclosure allows the magnetic coupling between the stator and the rotor to be significantly reduced in comparison with conventional motors. This can lead to a lower power capacity of the electric motor without additional adaptations. To compensate for this, additional measures may be taken, as partly described more specifically further below. For instance, superconducting elements may be used in the stator and/or in the rotor, in order to produce stronger electromagnetic interactions in a unit of a comparable or even smaller overall size. However, even with normally conducting components, measures can be taken to compensate for the lower coupling. For instance, the motor may for example be configured as longer in the axial direction than would be the case with a comparative motor with an outer iron yoke. Alternatively, the number of turns may be increased and/or, in the case of permanent-magnetic excitation, stronger permanent magnets may be used.

Generally and independently of the specific arrangement of the rotor and the stator, the electric motor may be designed particularly advantageously as a DC motor. It is then therefore a DC motor with an exciter device in the stator, which is a relatively common type of design for a DC motor. The exciter device of the stator may in this case have in particular at least one permanent magnet and/or at least one electrical excitation coil.

A DC motor is generally an electric motor that is operated with direct current. Particularly advantageously, such a DC motor is designed as an internal-rotor machine, since this is a commonly used type and a strong external magnetic field can be formed relatively easily by the external stator. However, this is not absolutely necessary and in principle an external-rotor machine can also be used as the DC motor.

A major advantage when using a DC motor as the electric motor of the drone is that, in particular when energy is supplied by a direct current source, no additional inverter is required. Such a direct current source may be provided for example by a battery and/or a fuel cell on board the drone. When using a fuel cell, it is particularly advantageous for it to be operated with hydrogen. This particularly applies if the electric motor has at least one superconducting element which is cooled to a cryogenic operating temperature with the aid of liquid hydrogen. In such a case, the hydrogen used for the cooling may be additionally used as fuel for the fuel cell.

Such a DC motor may have in the region of its rotor (in particular radially of an internal rotor) a commutator and one or more brushes. Such a commutator is a mechanical inverter, which converts a direct current fed from a current source into an alternating current required locally in the rotor. It is sometimes also referred to as a collector. The conversion takes place in a relatively easy way by the contacting of the rotor with fixed power supply lines mechanically changing during the rotation of the rotor. Such a commutator is therefore also referred to as a polarity reverser. The brushes serve in particular for the electrical contacting between the electrical components of the rotor and the fixed power supply lines.

The stator of the DC motor may also have further magnetic and/or electromagnetic elements in addition to the at least one magnetic and/or electromagnetic element for forming an excitation field—that is to say in addition to the primary exciter device. For example, in addition to an exciter winding, one or more commutating pole windings may be optionally arranged in the regions between the magnetic poles. Furthermore, one or more compensating windings may be optionally arranged additionally in the region of the stator. These optional commutating pole windings and compensating windings may be used for example in particular in the case of larger DC motors, in order to shape in a desired way the excitation field that is formed overall.

In the case of the embodiments in which the electric motor is designed as a DC motor and it has an excitation winding in the region of the stator, this is referred to as an electrically excited DC motor. Various embodiments come into consideration here in principle, differing in the type of electrical connection between the excitation winding and the armature winding. For example, it may be a series-wound machine, in which the excitation winding and the armature winding are electrically connected in series. Alternatively, it may be a shunt-wound machine, in which the excitation winding and the armature winding are electrically connected in parallel. According to a further alternative, it may however also be a separately excited machine, in which the circuits of the exciter winding and the armature winding are designed as electrically independent of one another. The last-mentioned variant is particularly advantageous in connection with superconducting excitation windings, in order to achieve decoupling to the greatest extent possible of the typically highly inductive superconducting excitation winding from the other components.

According to a further advantageous configurational variant, the electric motor of the drone may however also be designed as a synchronous motor. It is then therefore a synchronous motor with an exciter device in the stator, which is a relatively uncommon type of design for synchronous motors. Particularly advantageously, such a synchronous motor is designed as an internal-rotor machine, since a strong external magnetic field can be formed relatively easily by the external stator. However, this is not absolutely necessary and in principle an external-rotor machine can also be used as the synchronous motor.

A major advantage of using a synchronous motor is that, as a difference from the DC motor, no commutator is required, and under some circumstances also no brushes. However, an alternating current source is required. In the case of embodiments in which the drone has a direct current source for supplying energy to the electric motor (for example a battery or a fuel cell), an inverter is then additionally required and has to be designed for the relevant power range. If overall the alternating current is provided in the fixed region of the drone, the transmission unit is additionally required for the transmission of the alternating current from the fixed part into the rotating part of the machine. Under some circumstances, brushes and/or slip-ring contacts may be used for this.

When using a synchronous motor in the drone, the number of phases is not necessarily fixed at three. One advantage of a lower number of phases—in particular a number of phases of two—can be seen in that the number of slip rings required for transmitting the alternating current from the fixed part into the rotating part is correspondingly reduced.

Generally advantageously and independently of the design otherwise of the electric motor, the at least one element arranged in the stator for forming an excitation field may be a permanent magnet. A major advantage when using such a permanent magnet is that, by contrast with using an excitation coil, no additional electrical energy supply in the region of the stator is required for forming the excitation field. The at least one permanent magnet may be in principle either a conventional permanent magnet (typically on the basis of rare earth materials such as for example NdFeB) or a superconducting permanent magnet.

As an alternative to the aforementioned embodiment, the at least one element arranged in the stator for forming an excitation field may however also be an electrical excitation coil. Such an electrical excitation coil may in principle also be part of the exciter device in addition to a permanent magnet. In particular when a superconducting excitation coil is used, in the case of this variant a comparatively high magnetic flux density can be achieved, in particular also outside the electric motor, with a comparatively small required power capacity (which includes the cooling capacity for cooling the superconductor).

Generally and independently of the specific design of the electric motor, it may comprise at least one superconducting element. With such superconducting materials, comparatively high magnetic fields can be generated with relatively small and lightweight components, which contributes in a particularly advantageous way to the aim of providing a small and lightweight drone. In principle, the electrical components of the rotor and the stator may however also exclusively comprise normally conducting components, and the basic concept of the present invention can nevertheless be realized.

The stator of the electric motor may advantageously comprise in particular at least one block of superconducting material impressed with a magnetic flux in such a way that the at least one block acts like a permanent magnet. In particular, such a block may be a block of bulk superconductor material. There may particularly advantageously also be a number of such blocks, in order to generate a particularly high, constant magnetic field.

Various methods that are known in the prior art are available for impressing superconductors with a permanently magnetic flux. Thus, for example, a magnetic flux may be impressed at a temperature above the transition temperature at the location of the superconductor with an external magnetic coil or else a permanent magnet and then frozen in the superconducting material by cooling down to a temperature below the transition temperature of the superconductor. Such methods are known in the prior art by the terms “field cooling” and “zero field cooling”. An alternative method is the method of the flux pump. The superconducting material is in that case impressed with a magnetization by magnetic field pulses at a cryogenic temperature below the transition temperature. All of these methods have in common that, after removing the external magnet that is used for the magnetization, the magnetic flux is retained in the superconductor and the latter acts as a permanent magnet as long as it is kept at a temperature below its transition temperature.

As an alternative or in addition to the embodiment with solid blocks of superconducting material throughout, such blocks may also be made up in each case of a plurality of superconducting strip conductors. In particular, such a block may be formed as a stack of such strip conductors. Here, too, the respective block may be impressed with a magnetic flux in such a way that the block acts like a permanent magnet, as described above.

Generally, all of the embodiments in which a superconducting material of the stator is permanently impressed with a magnetic flux have the advantage that no energy is required to maintain the excitation field. Accordingly, no power supply lines from the warm outer surroundings to the cryogenic surroundings of the superconductor material are required either, and the thermal losses in the cooling of the superconductor to a temperature below its transition temperature can be kept advantageously low. Since such superconducting components cannot just be easily magnetized but also easily demagnetized—for example by heating—they can also be easily transported. For example, requirements for electromagnetic compatibility can then be easily met if the superconducting components of the drone are not magnetized as long as they are not in use.

As an alternative or in addition to the superconductor acting as a permanent magnet, the stator may have at least one superconducting excitation coil. Such an excitation winding of the stator may be supplied with electrical energy for example by way of a direct current source. As a result of the negligible electrical losses of such a superconducting excitation winding, it is however also possible in principle to operate this winding in a quasi persistent current mode. This is of interest especially in the case of such embodiments in which the magnetic field decreases by less than 1% per hour in the short-circuited operating mode. Then the excitation winding of such a drone can be charged by an external power source before its use, and the excitation winding of the drone can be operated during its use of for example several hours without a power source for the excitation winding(s). In the case of such an embodiment, it is also possible to dispense with electrical connections of the excitation winding, as a result of which the thermal losses in the cryogenic surroundings of the superconducting winding(s) can be reduced.

In principle, much stronger magnetic fields can be obtained with superconducting excitation coils than with conventional normally conducting excitation coils of a similar size and type. Or, to put it another way, with a similar power capacity and similar magnetic flux, the electric motor can be configured as smaller and lighter than with normally conducting windings, for example conventional copper windings. As a result of the low losses, the energy requirement is likewise lower than with conventional conductors, so that less electrical power is required even in the case of operation with power permanently supplied, and an energy store of the drone can accordingly be designed for a lower energy consumption.

As an alternative or in addition to the described superconducting components in the stator, the electric motor may also be designed in such a way that its armature winding in the rotor comprises a superconducting electrical conductor. Here, too, much higher currents and/or much higher numbers of turns can be obtained with the same overall volume in comparison with conventional copper windings. As an alternative or in addition, the overall volume, and consequently also the weight, of the drone can also be reduced in comparison with a motor with normally conducting materials.

Generally and independently of whether the superconducting material is used in the rotor and/or in the stator, this material may be designed as high-temperature superconducting material. High-temperature superconductors (HTS) are superconducting materials with a transition temperature above 25 K, and above 77 K in the case of some material classes with which the operating temperature can be achieved by cooling with cryogenic materials other than liquid helium. HTS materials are also particularly attractive because, depending on the choice of operating temperature, these materials can have high upper critical magnetic fields and high critical current densities. Therefore, high magnetic fields can be generated with them particularly easily.

Particularly advantageously, such a high-temperature superconducting material may comprise magnesium diboride and/or a material of the type REBa₂Cu₃Oₓ, where RE stands for a rare earth element or a mixture of such elements. With superconducting windings in the rotor and/or in the stator, the superconducting conductor may be advantageously configured as a strip conductor.

The drone may advantageously have an energy store for storing electrical or chemical energy for the operation of the electric motor. In particular, the drone may have an electrical battery and/or a fuel cell and/or it may have a fuel tank for an electrical generator. Alternatively, in principle the drone may however also be supplied with energy during use from a control system, for example a larger ship, while connected by cable.

The drone may advantageously be designed in such a way that the electric motor forms the only magnetic triggering system for triggering naval mines. Then therefore in particular there are no further magnetic coils or permanent magnets for generating an external magnetic field above the triggering threshold of naval mines. In the case of such an embodiment there may however also quite easily be an additional acoustic triggering system for triggering acoustic mines. In principle, it is also conceivable that there is yet a further magnetic triggering system, for example if a magnetic flux distribution deviating from the magnetic field of the electric motor is to be produced or if a time-variable magnetic flux is to be produced.

Particularly advantageously, the electric motor may have a number of pairs of poles p of between 1 and 5. In the case of such a comparatively low number of pairs of poles, a magnetic flux with a relatively high outward radial range can be produced. Consequently, a relatively high external magnetic field can be easily provided for triggering the mines.

The drone may be advantageously designed to be moved under water. As an alternative to this, it may however in principle also be designed as a drone floating on the surface of the water.

### BRIEF DESCRIPTION OF THE DRAWINGS

The invention is described below on the basis of several advantageous exemplary embodiments with reference to the appended drawings, in which:

FIG. 1 shows a drone 1 in a schematic longitudinal section and

FIGS. 2 to 5 show electric motors 3 by way of example in schematic cross section.

### DETAILED DESCRIPTION OF INVENTION

In the figures, elements that are the same or functionally the same are provided with the same designations.

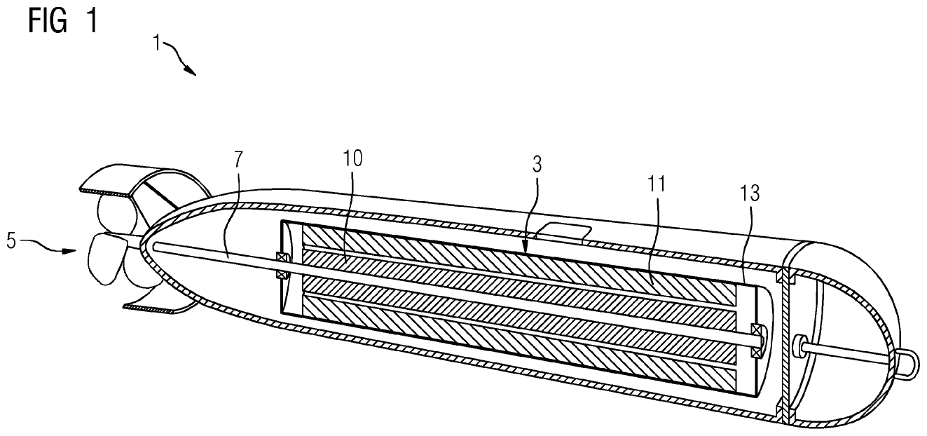

In FIG. 1, a drone 1 according to a first exemplary embodiment of the invention is shown in schematic longitudinal section. A drone of an elongated shape, designed for locomotion under water, is shown. It has in its rear part (shown on the left in the drawing) a propeller. The drone is therefore equipped with a drive system of its own, the propeller being driven here by way of a rotor shaft 7 of an electric motor 3. In the case of this exemplary embodiment, the electric motor 3 takes up a large part of the space available inside the drone. However, the space taken up by the electric motor 3 may in principle also end up being smaller, for example to provide space for a control unit for controlling the motor and other steering units for the drone that are not shown here. Furthermore, inside the drone there may also be an energy store, likewise not shown here, in the form of a battery or a fuel cell with a fuel supply. Alternatively, a fuel tank, for example a diesel tank, and a generator for supplying the motor with electrical energy may be provided. Or else the electric motor 3 may be supplied with electrical energy by way of an electric cable not shown here.

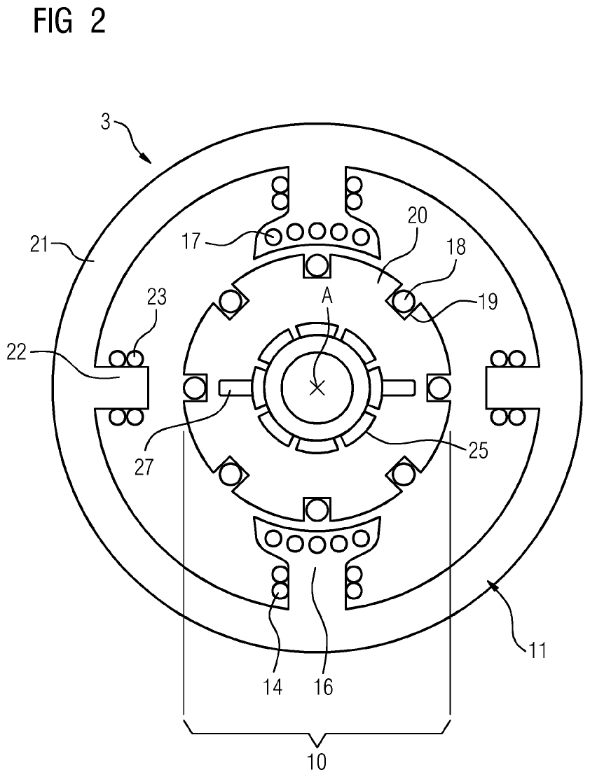

The electric motor 3 has a rotor 9, which is arranged on the rotor shaft 7 and is coupled to it in a torque-locking manner in such a way that the propeller 5 can be driven by way of the rotor shaft 7. The electric motor 3 also has a stator 11, which is arranged radially outside the rotor 9. Therefore, this is an internal-rotor motor. In the case of this motor, the external stator bears an exciter device, and the internal rotor bears an actuator winding. In principle, the motor may either be a DC motor or a synchronous motor, as will become even more clear in connection with FIGS. 2 to 4.

FIG. 2 shows a schematic cross section of such an electric motor 3 in a special exemplary embodiment of the drone. The external stator 11 surrounds the internal rotor 10 in the form of a ring, the rotor 10 being mounted rotatably about the central axis of rotation A. In this case, the internal rotor 10 comprises a rotor support 20. This rotor support 20 has in the region of its outer surface a plurality of armature slots 19, in which an armature winding 18 is embedded. In the radially further inner-lying region of the electric motor, brushes 27 for electrical contact with fixed power supply lines are also provided. Also arranged here is a commutator 25, which acts as a mechanical inverter, so that a direct voltage on the fixed power supply lines periodically changes its sign within the rotor. The brushes 27 and the commutator 25 do not necessarily have to be arranged at the same axial position as the other components that are shown in FIG. 2. They may possibly also be arranged axially offset in relation to the armature winding. The representation of FIG. 2 should be understood as only extremely schematic with respect to these elements.

The external stator 11 comprises a stator support 21, which has a circular-cylindrical outer contour. This stator support bears an exciter device, which in the example shown is designed for forming a two-pole magnetic field. The number of pairs of poles p here is therefore p=1. In this example, the exciter device comprises two excitation coils 14, which are arranged on pole supports 16 of the stator lying opposite one another. These pole supports 16 are in each case shaped radially inward to form pole shoes and additionally bear in each case a compensating coil 17 in the region of these pole shoes. Furthermore, the stator support 21 has between the two pole supports 16 in the circumferential direction two commutating pole supports 22, on which a commutating pole coil 23 is in each case arranged. The compensating coils 17 and commutating pole coils 23 in this case assist the spatial shaping of the magnetic excitation field generated overall by the exciter device (and in particular the excitation coils 14). The magnetic excitation field generated in this way in turn interacts electromagnetically with the internal rotor 10, and in particular with the armature winding 18 arranged on it. This electromagnetic interaction has the effect in particular of bringing about a conversion of electrical energy into the mechanical energy of the rotation within the electric motor 3. In addition, this electromagnetic interaction also has the effect of influencing the magnetic excitation field, so that overall a superordinate magnetic field B of the electric machine is obtained.

In the case of the electric motor 3 of the exemplary embodiment shown, the stator support 21 is formed completely from an amagnetic material, for example an amagnetic steel. As a result, as a difference from electric motors that are typically used, the magnetic flux is not enclosed within the motor in the form of a ring. This advantageously brings about the effect that the magnetic flux formed can spread out radially far into regions outside the stator and be used there for triggering magnetic mines. The radially further inner-lying rotor support 20 may optionally either also be formed from an amagnetic material or else it may also be formed from a soft-magnetic material for the magnetic flux guidance within the rotor. Soft-magnetic materials in the radially inner region of the rotor 10 do not prevent the magnetic field from spreading into the radially further outer-lying regions outside the electric motor.

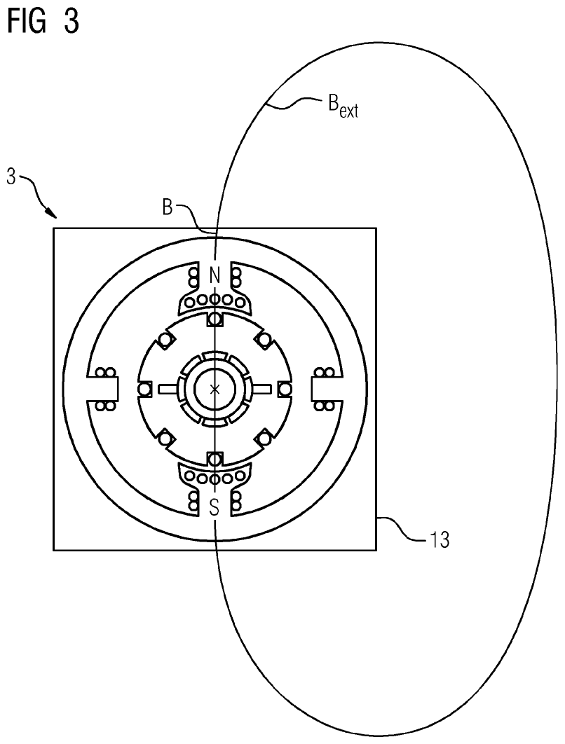

In FIG. 3, a scaled-down representation of the electric motor 3 from the example of FIG. 2 is shown, an outer motor housing 13 also being shown in addition to the previously described components. Furthermore, a field line is shown by way of example for the superordinate magnetic field B that is formed by the interaction of the rotor and the stator. This magnetic field B also spreads into the regions outside the motor housing 13 and is correspondingly denoted there by Bₑₓₜ. Since the magnetic field Bₑₓₜ present outside the electric motor is provided essentially by the excitation field of the fixed stator and is only slightly influenced by the interaction with the rotating rotor, this is a constant magnetic field. However, the amplitude may vary periodically due to the influence of the rotor.

The motor housing 13 has here a rectangular cross section. As an alternative to this, it may however also have a round, in particular circular, cross section, or at least the cross section may have rounded corners or be formed as a polygon with more than four corners, in order that the electric motor 3 takes up less space inside the drone. The electric motor 3 is in any case designed overall in such a way that an external magnetic field Bₑₓₜ with a magnetic flux density suitable for triggering naval mines can also be generated outside the motor housing 13. It is therefore intended to be an electric motor 3 with overall particularly weak shielding.

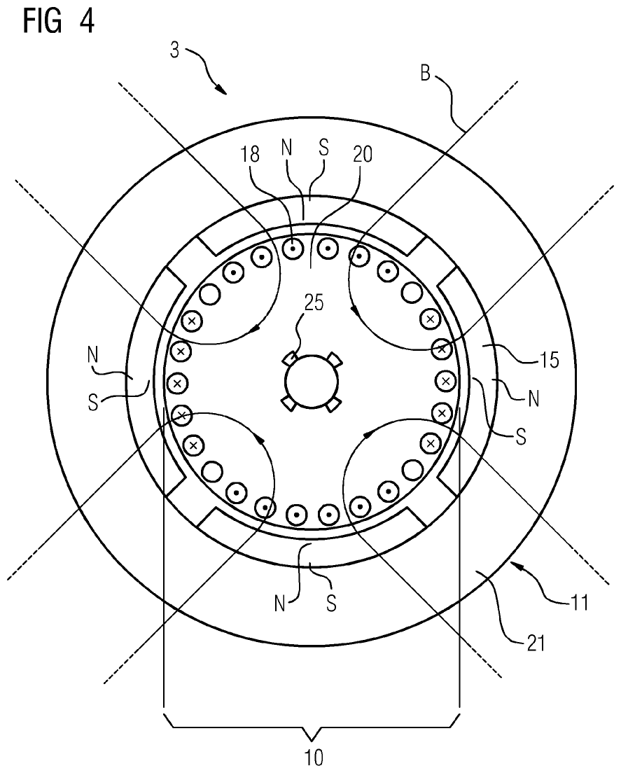

FIG. 4 shows an electric motor 3 according to a further example of the invention in schematic cross section. This electric motor is also designed as a DC motor. Here, too, a commutator 25 is provided inside the electric motor—possibly at a different axial position—as well as brush contacts, which for the sake of overall clarity are not shown in FIG. 4. As a difference from the example of FIGS. 2 and 3, instead of excitation coils, the stator 11 of this electric motor is equipped with a plurality of permanent magnets 15 as an exciter device. In the example shown, these are four permanent magnets 15, which are arranged on the inside of the stator support 21. The permanent magnets 15 are distributed uniformly over the circumference of the stator and alternate in their radial orientation of the magnetic north pole N and magnetic south pole S. Here, too, the four-pole excitation field (p=2) formed in this way interacts electromagnetically with the armature winding 18 arranged on the rotor support 20 of the rotor 10. In a way similar to in the case of the example of FIGS. 2 and 3, here, too, the stator support 21 is formed from an amagnetic material. In this way it is achieved that the magnetic field B formed overall by the electric machine 3 can spread out far, and a strong external constant magnetic field Bₑₓₜ suitable for triggering naval mines is also generated outside the electric motor.

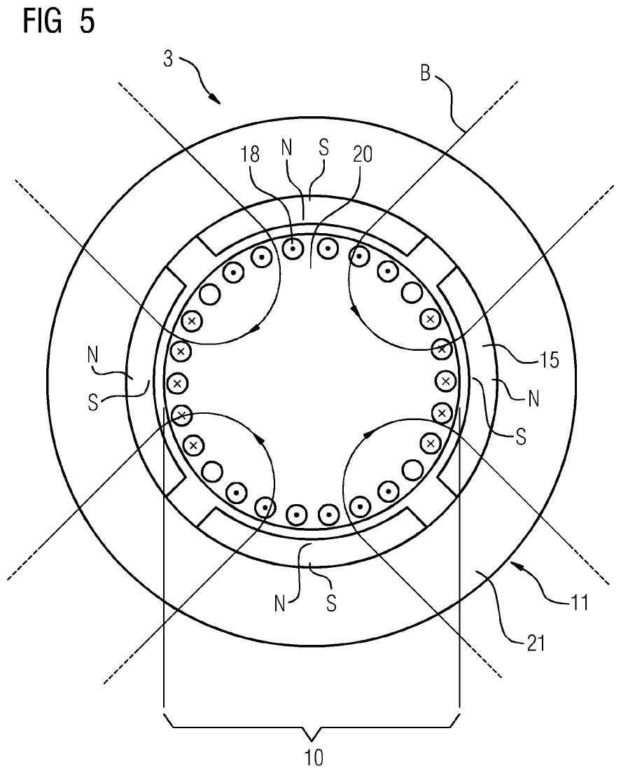

FIG. 5 shows an electric motor 3 according to a further exemplary embodiment of the invention. The overall construction of the electric motor is similar to in the case of the previous example. Thus, here, too, an external stator 11 is arranged radially around an internal rotor 10, the stator 11 bearing an exciter device comprising four permanent magnets 15 and the rotor 10 bearing an armature winding 18. Here, too, the stator support 21 is formed from an amagnetic material, so that the superordinate magnetic field B of the machine can spread out far. As a difference from the example of FIG. 4, however, here the electric motor 3 is designed as a synchronous motor and not as a DC motor. Correspondingly, the commutator is absent here, and the armature winding 18 of the rotor 10 is connected to an alternating current source that is not shown here. Such an alternating current source may for example also be formed by a combination of a direct current source and an inverter.

The permanent magnets 15 from the examples of FIGS. 4 and 5 may be formed either as classic permanent magnets (in particular with rare earth materials) or else as superconducting permanent magnets. In this way, particularly strong magnetic fields can be obtained. In the case of the example of FIGS. 2 and 3, the excitation winding with the excitation coils 14 can be realized as a superconducting excitation winding.

### LIST OF DESIGNATIONS

1 Drone
3 Electric motor
5 Propeller
7 Rotor shaft
10 Rotor
11 Stator
13 Motor housing
14 Excitation coil
15 Permanent magnet
16 Pole support
17 Compensating coil
18 Armature winding
19 Armature slot
20 Rotor support
21 Stator support
22 Commutating pole support
23 Commutating pole coil
25 Commutator
27 Brush
A Axis of rotation
B Magnetic field
Bₑₓₜ External magnetic field
N North pole
S South pole

1. A drone for triggering naval mines, comprising:
a drive with an electric motor for locomotion in the water,
wherein the electric motor is useable during operation of the drone for triggering the naval mines, by means of an external magnetic field formed by the operation of the electric motor,
wherein the electric motor comprises a fixed stator and a rotor mounted rotatably in relation to the stator,
wherein the stator has at least one magnetic and/or electromagnetic element for forming an excitation field,
wherein the rotor has at least one armature winding, which during the operation of the electric motor interacts electromagnetically with the excitation field, whereby a superordinate magnetic field is formed, and
wherein the external magnetic field formed during operation outside the electric motor is formed as a constant magnetic field.

2. The drone as claimed in claim 1,
wherein the electric motor is formed in such a way that the rotor is arranged radially inside the stator.

3. The drone as claimed in claim 1,
wherein the electric motor is formed in such a way that the stator is arranged radially inside the rotor.

4. The drone as claimed in claim 1,
wherein the stator has a stator support and/or the rotor has a rotor support, wherein the magnetic properties of the stator support and/or the rotor support are designed in such a way that during the operation of the electric motor a magnetic flux of at least 0.5 mT can spread into a region outside the electric motor.

5. The drone as claimed in claim 4,
wherein the stator support and/or the rotor support is formed at least in some portions from a material that has an effective permeability number μᵣ of at most 300.

6. The drone as claimed in claim 1,
wherein the electric motor is designed as a DC motor.

7. The drone as claimed in claim 1,
wherein the electric motor is designed as a synchronous motor.

8. The drone as claimed in claim 1,
wherein the at least one element arranged in the stator for forming an excitation field is a permanent magnet.

9. The drone as claimed in claim 1,
wherein the at least one element arranged in the stator for forming an excitation field is an electrical excitation coil.

10. The drone as claimed in claim 1,
wherein the electric motor comprises at least one superconducting element.

11. The drone as claimed in claim 10,
wherein the stator comprises at least one block of superconducting material impressed with a magnetic flux in such a way that the at least one block acts like a permanent magnet.

12. The drone as claimed in claim 10,
wherein the stator comprises at least one block, wherein each block comprises in each case a plurality of stacked superconducting strip conductors, and wherein the respective block is impressed with a magnetic flux in such a way that the block acts like a permanent magnet.

13. The drone as claimed in claim 10,
wherein the stator has at least one superconducting excitation coil.

14. The drone as claimed in claim 10,
wherein the at least one armature winding has a superconducting electrical conductor.

15. The drone as claimed in claim 10,
wherein the at least one superconducting element comprises a high-temperature superconducting material.

16. The drone as claimed in claim 5,
wherein the stator support and/or the rotor support is formed at least in some portions from a material that has an effective permeability number μᵣ of at most 10.

17. The drone as claimed in claim 15,
wherein the at least one superconducting element comprises a high-temperature superconducting material comprising magnesium diboride and/or a material of the type REBa₂Cu₃Oₓ.
